(19) United States
(12) Patent Application Publication
(10) Pub. No.: US 2012/0192155 A1
(43) Pub. Date: Jul. 26, 2012

(54) CODE ADVISOR FOR WEB COMPATIBILITY AND INTEROPERABILITY

(75) Inventors: Marc A. Silbey, Mercer Island, WA (US); Anthony M. Ross, Redmond, WA (US); Jim A. Moore, Redmond, WA (US)

(73) Assignee: MICROSOFT CORPORATION, Redmond, WA (US)

(21) Appl. No.: 13/010,552

(22) Filed: Jan. 20, 2011

(51) Int. Cl. G06F 11/36

(52) U.S. Cl. 717/125

(57) ABSTRACT

Various embodiments provide an investigative tool to enable webpage content to be analyzed. In at least some embodiments, the investigative tool, hereinafter “code advisor”, allows the use of Application Programming Interfaces (APIs) to be tracked. By tracking API use as script for a webpage executes, the code advisor can determine if compatibility and/or interoperability issues exist in regards to webpage content. If an issue does exist, in at least some embodiments, code advisor can select one or more messages associated with the issue and provide guidance to enable the issue to be addressed.

### BACKGROUND

Previously, when web platforms changed, there has been no easy way for developers to identify if web pages on their web site will encounter issues with a new web platform. Consequently, developers have had to read documentation about the new platform and manually trace code changes to assess compatibility and interoperability issues. Alternatively, developers have had to run expressions against source code to perform a source code analysis. Existing tools are generally static and do not, often times, provide desirable conflict resolution for compatibility issues.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide an investigative tool to enable webpage content to be analyzed. In at least some embodiments, the investigative tool, hereinafter “code advisor”, allows the use of Application Programming Interfaces (APIs) to be tracked. By tracking API use while script for a webpage executes, the code advisor can determine if compatibility and/or interoperability issues exist in regards to webpage content. If an issue does exist, in at least some embodiments, the code advisor can select one or more messages associated with the issue and provide guidance to enable the issue to be addressed.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates a system architecture that can be employed in accordance with one or more embodiments.

FIG. 3 illustrates a web browser investigative tool user interface in accordance with one or more embodiments.

FIG. 4 illustrates aspects of a web browser investigative tool user interface in accordance with one or more embodiments.

FIG. 5 illustrates issue resolution aspects of a web browser investigative tool user interface in accordance with one or more embodiments.

FIG. 6 illustrates an emulated webpage and web browser investigative tool user interface in accordance with one or more embodiments.

FIG. 7 is a flow diagram that describes steps in a method in accordance with one or more embodiments.

FIG. 8 illustrates an example system that can be utilized to implement one or more embodiments.

### DETAILED DESCRIPTION

Overview

Various embodiments provide an investigative tool, termed a “code advisor”, to enable webpage content to be analyzed. In at least some embodiments, the code advisor allows the use of Application Programming Interfaces (APIs) to be tracked. By tracking API use as script for a webpage executes, the code advisor can determine if any compatibility and/or interoperability issues exist in regards to webpage content. If an issue does exist, in at least some embodiments, the code advisor can select one or more messages associated with the issue and provide guidance to enable the issue to be addressed. As used herein, the term “issue” will be understood to include, by way of example and not limitation compatibility and/or interoperability issues associated with the manner in which a webpage interacts with a web browser.

In at least some embodiments, if an issue is identified, a message can be displayed for the user or developer. The message can provide a description of the issue so that the developer is apprised of the issue. Alternately or additionally, the message can provide a selectable fix option that is directed to mitigating the issue. The fix option, when selected, can dynamically provide a fix for the issue. In some instances, the dynamic fix can emulate the behavior the webpage was expecting, thus providing immediate feedback with respect to the issue and, in at least some instances, its resolution.

In the discussion that follows, a section entitled “Operating Environment” is provided and describes one environment in which one or more embodiments can be employed. Following this, a section entitled “Example Embodiment” describes an example embodiment in which a code advisor can be employed. Next, a section entitled “Example Method” describes a method in accordance with one or more embodiments. Last, a section entitled “Example System” describes a system that can be utilized to implement one or more embodiments.

Consider now an example operating environment in which one or more embodiments can be implemented.

Operating Environment

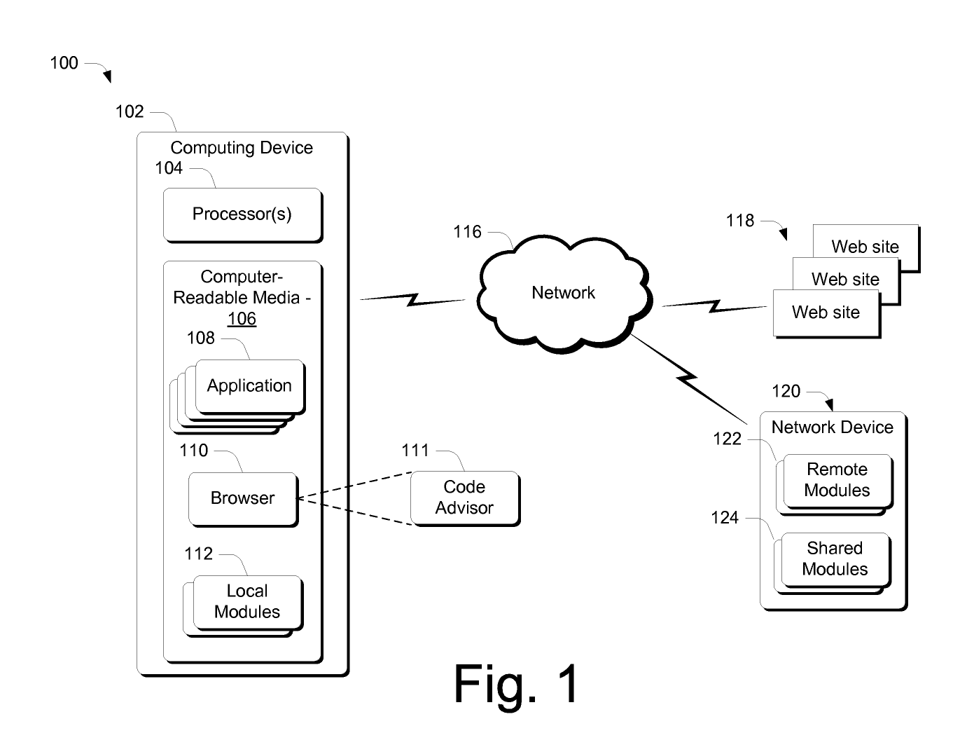

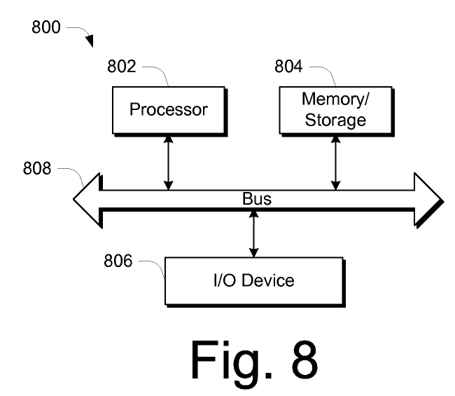

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 8.

In addition, computing device 102 includes a software application in the form of a web browser 110. Any suitable web browser can be used examples of which are available from the assignee of this document and others. In addition, computer-readable storage media 106 can include a code advisor 111 that operates as described above and below. Code advisor 111 can be implemented as a standalone component that can be utilized by applications 108 and browser 110. Alternately or additionally, the code advisor 111 can be implemented as part of applications 108 or browser 110, such as a browser development tool.

In one or more embodiments, code advisor 111 can access or otherwise utilize modules located on computing device 102, such as local modules 112. Local modules 112 can be library modules associated with the code advisor and its functionality. Additionally or alternatively, local modules 112 can be customized modules created for use by a browser 110. Examples of modules are described below.

In operation, code advisor module 111 executes in conjunction with webpage content being received from a website. Code advisor 111 can register one or more overrides on APIs that make up a browser platform. This allows code advisor 111 to effectively “wrap” an API and to monitor input, state, and output values associated with the API and its use by a particular webpage. Thus, when a particular API is called by a webpage, code advisor 111 intercepts the call and redirects the call to an associated module, such as one of local modules 112. The module is knowledgeable of the API, its operation, and how it should perform in an operational scenario. Accordingly, the module is designed to inspect parameters and values associated with the API call and assess whether compatibility or interoperability issues exist. Inspection of API parameters and values, and consequently, determination of whether a particular issue associated with the API exists, enables the code advisor 111 to select, when appropriate, a displayable message that can be displayed to provide information on the issue and, in at least some embodiments, its resolution.

In addition, environment 100 includes a network 116, such as the Internet, and one or more web sites 118 from and to which content can be received and sent. Such content can include webpage content, such as HTML, script and the like, that can be operated upon by code advisor 111 as described above and below. Network 116 may also be representative of an intranet through which computing device 102 may communicate with one or more network devices 120.

Network device 120 can be as embodied as any network device such as, by way of example and not limitation, a network server, a desktop computer, a portable computer, a handheld computer such as a personal digital assistant (PDA), cell phone, and the like. Network device 120 can also contain modules that are accessible and loadable by code advisor 111. The modules can include both remote modules 122 and shared modules 124. The shared modules 124 can be created and shared by third party developers.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of how issue detection is performed in accordance with one or more embodiments.

Example Embodiment

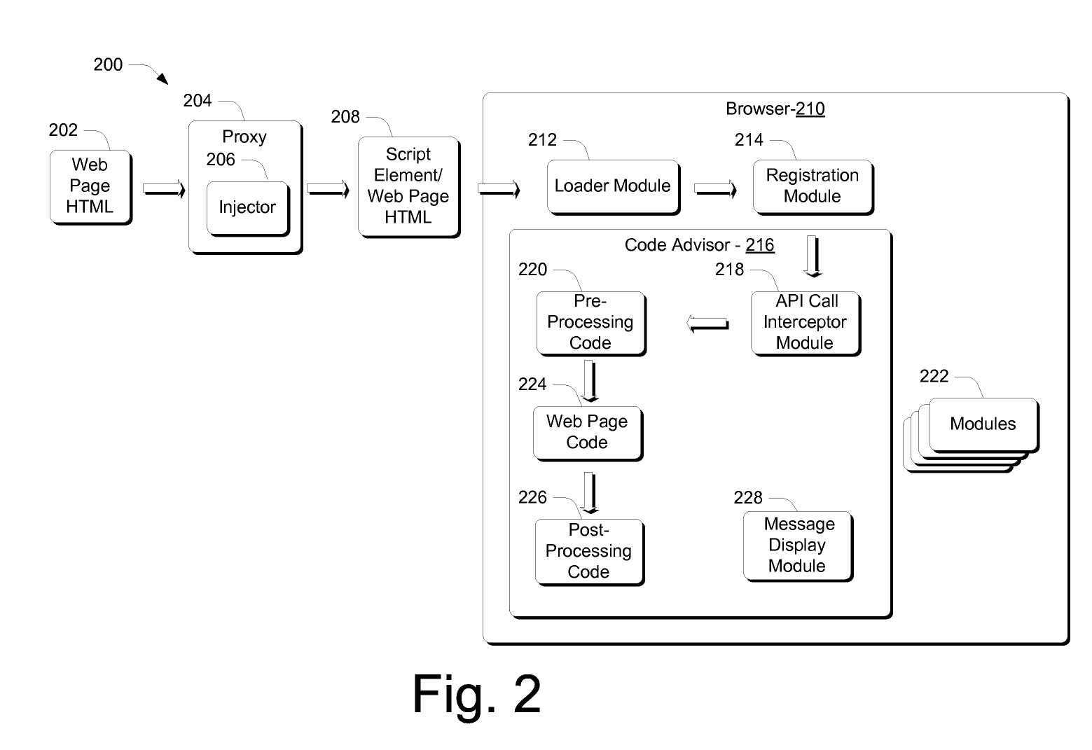

FIG. 2 illustrates, generally at 200, an example architecture in accordance with one or more embodiments. In this embodiment, web page HTML 202 is received by a proxy 204. Proxy 204 includes an injector 206 that is configured to insert one or more script elements at the beginning of web page HTML 202, the combination of which is diagrammatically represented by script element/web page HTML 208. The inserted script element may be any suitable type of script element including, by way of example and not limitation, a Javascript element and the like. The script element(s) enables additional code to be executed by the browser prior to execution of web page HTML 202. In another embodiment, the script element(s) may execute simultaneously with web page HTML.

In the illustrated and described embodiment, browser 210 includes a loader module 212, a registration module 214, a code advisor 216 and one or more modules 222.

In one embodiment, loader module 212 receives the script element/web page HTML 208. Upon receiving script element/web page HTML 208, loader module 212 loads an architectural framework including code advisor 216. Additionally, loader module 212 can also load one or more modules 222 that are designed to analyze API calls as described above and below. Although FIG. 2 illustrates code advisor 216 and modules 222 as being located inside browser 210, it is not intended to depict code advisor 216 and modules 222 as being limited to that one embodiment. As such, code advisor 216 may run “on top” of browser 210. Alternatively or additionally, modules 222 may run on top of the browser and may or may not be integrated with code advisor 216.

In one or more embodiments, registration module 214 permits modules 222 to register code with code advisor 216 to execute before or after an application programming interface (API) is called by a web page. Thus, the modules 222 register code with registration module 214 in order to direct code advisor 216 to “wrap” an associated API and monitor parameters and values associated with calls to the API.

Wrapping can be performed using any suitable type of technology, as will be appreciated by the skilled artisan. As but one example, wrapping can be performed utilizing Microsoft's Detours technology. Other techniques can be used, such as those described below.

In the illustrated and described embodiment, code advisor 216 contains preprocessing code 220 and post-processing code 226 that works in concert with the modules 222.

The preprocessing code 220 and post-processing code 226 enables modules 222 to monitor parameters and values associated with a corresponding API call by a web page and, more particularly, web page code 224. As the web page begins to execute inside browser 210, the web page code 224 can make an API call to an API that is wrapped by the code advisor. The API call is intercepted by API call interceptor module 218.

In operation, when API call interceptor module 218 intercepts the API call, code advisor 216 uses pre-processing code 220 to cause the API call to be redirected to a module represented by modules 222. Modules 222 analyze input values of the API call prior to the call actually being completed to the API. Input values include API call parameters, arguments and the like.

Modules 222 can determine whether there is an issue with one or more input values of an API call and if so, can send a message related to that issue to message display module 228 which can cause a message to be displayed for the user, examples of which are provided below.

If no issue is detected with the input values of the API call (or in the event any issues have been fixed), the API call can actually be made by the web page code 224 and post-processing code 226 can monitor any return values as a result of the API call. The return values ascertained by the post-processing code can then be provided to the appropriate module 222 for processing to identify whether any issues exist with respect to the return values. If an issue is identified to exist, module 222 can send a message related to that issue to message display module 228 so that an appropriate message can be displayed.

Message display module 228 can permit various types of messages to be displayed.

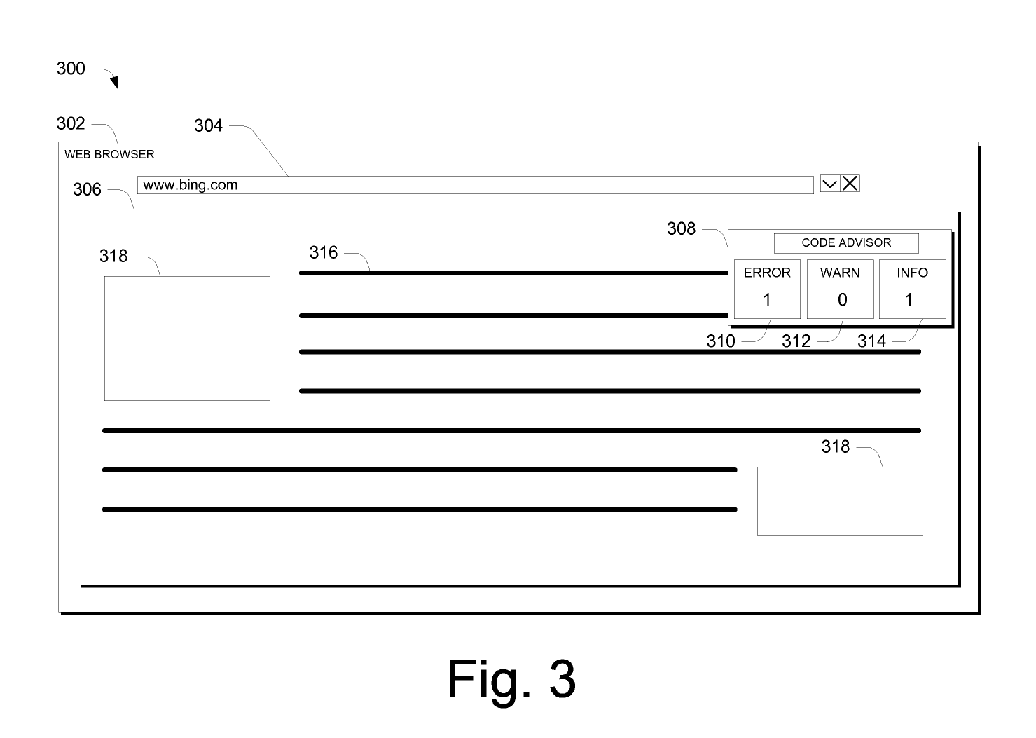

As an example, consider FIG. 3 which illustrates a web browser investigative tool user interface in accordance with one or more embodiments, generally at 300. In this example, web browser 302 has text associated with the URL “www.bing.com” in the address bar 304. Page 306 has loaded inside browser 302 containing text 316 and two empty frames 318. Code advisor 308 is illustrated in a minimized view. In this embodiment, code advisor 308 is displayed on top of web page 306. However, other code advisor displays are possible including, but not limited to, a display in the chrome of the browser, as a sidebar, etc. In this example, code advisor 308 has three types of messages associated with it: error message 310, warn message 312, and info message 314. Although these three types of messages are illustrated, other types of messages can be utilized.

In the illustrated and described embodiment, error message 310 is displayed with a number indicating the number of error messages available for viewing. Similarly, warn message 312 and info message 314 indicate the number of their respective messages as well. Alternatively, if no messages are present for a type of message, there may be no display of the message type.

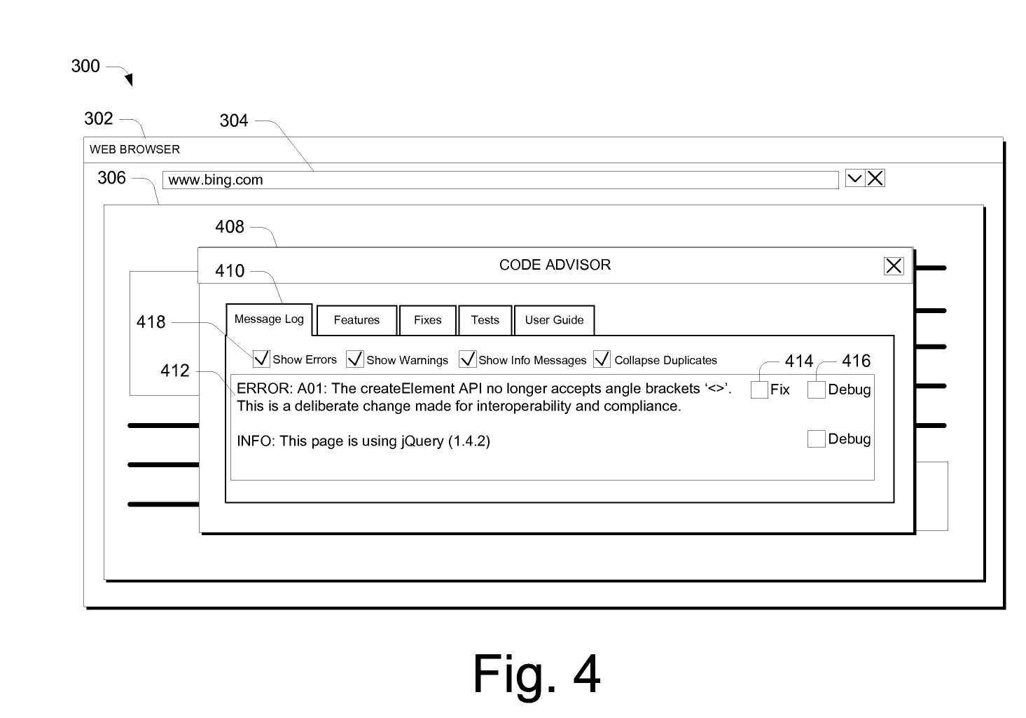

In one or more embodiments, the display associated with code advisor 308 can be expanded. For example, by clicking on the code advisor, it can be expanded into a form that provides additional information. As an example of an expanded code advisor 308, consider FIG. 4 which uses like designators from FIG. 3.

In FIG. 4, code advisor 408 is displayed as a window inside webpage 306. As discussed above, other displays can be utilized. In one embodiment, code advisor 408 contains a series of tabs to allow a user to easily navigate the content of code advisor 408.

Message log tab 410 is currently selected. Message log tab 410 contains viewing options such as show errors 418 to allow the messages to be easily sorted and managed. Other viewing options can be utilized in addition to the illustrated viewing options.

Message log tab 410 also contains error message 412. In this example, error message 412 can be a longer explanation of the error message 310 displayed in code advisor 308 in FIG. 3. Error message 412 can provide an indication of which API it is associated with and can additionally describe the error that occurred with regards to the API call. Error message 412 can further provide an explanation of the error description such as, for example, “This is a deliberate change made for interoperability and compliance”. Alternatively, these descriptions may be provided when a mouse hovers over an error, in a separate window.

In one or more embodiments, error message 412 can be displayed with prompts for a user to perform an action. The action can be selection of an option such as fix option 414 and/or debug option 416.

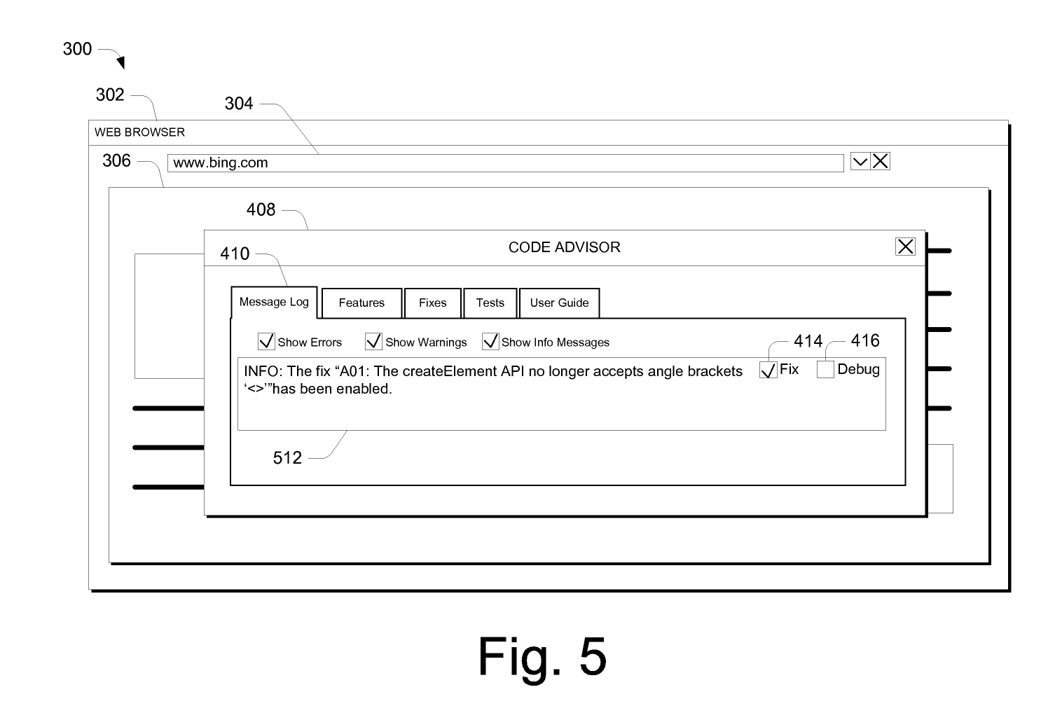

In this example, fix option 414 can allow a user to confirm the displayed error message 412 and enable a fix to be implemented for the error. As an example, consider FIG. 5.

There, responsive to a user selecting fix option 414 error message 412 is no longer displayed. Rather, info message 512 informs the user that a fix for error message 412 has been enabled. In an alternative embodiment, both error message 412 and info message 512 can be displayed.

In one or more embodiments, the enabled fix can be displayed as an emulated behavior of the webpage. The emulated behavior can be displayed immediately or may not be displayed until a user refreshes the page, minimizes code advisor, or performs another action. The enabled fix can permit the emulated behavior to be displayed by utilizing redirection to a different API than the web page was calling. In an embodiment, the redirection to a different API can be specified by a module, such as modules 222 described above. In an example, the emulated behavior can be a legacy behavior based on redirection to a browser API of a previous version of the browser.

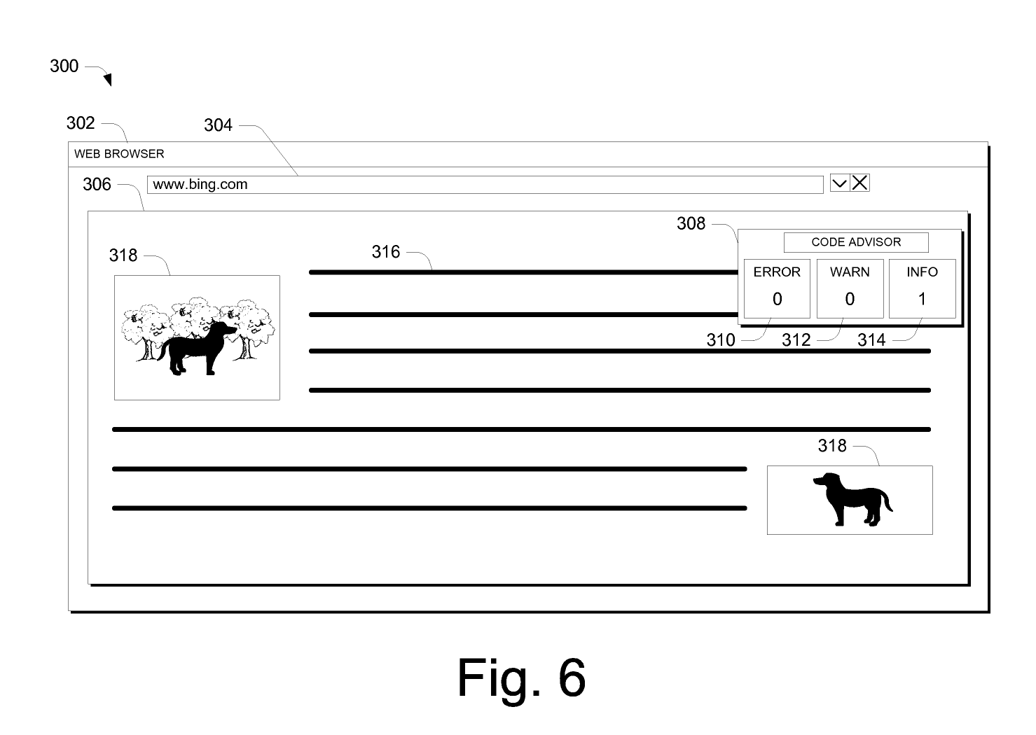

As shown in FIG. 6, code advisor 308 can be minimized to include the message types described above. Web page 306 now contains pictures displayed in inside frames 318 that were not previously displayed. The emulated behavior provided by the enabled fix permits the page to execute as the web page was expecting.

Additionally, in some embodiments, an error message 412 (FIG. 5) displays a debug option 416. Debug option 416 when checked or otherwise selected, provides guidance as to how resolve the error message 412. Examples of guidance include but are not limited to: a link into user documentation, a link into code, highlighted or otherwise visually-indicated code, additional information regarding standards compliance, navigation to an area in code where the error occurred, and/or a list of code pertaining to the issue. Additionally, debug option may provide an automatic correction of code when selected by itself or when selected with fix option 414.

Having considered the various embodiments, consider now an example method that can be implemented in accordance with one or more embodiments.

Example Method

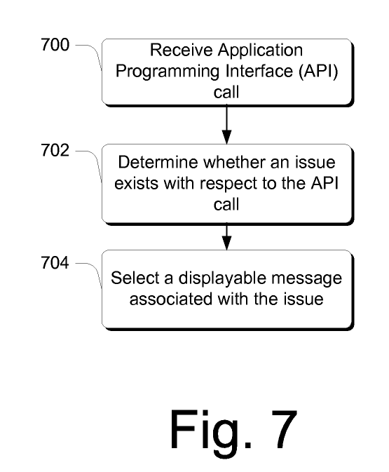

FIG. 7 is a flow diagram that describes steps in a method in accordance with one or more embodiments. The method can be implemented in connection with any suitable hardware, software, firmware or combination thereof In at least some embodiments, aspects of the method can be implemented by a suitably configured code advisor component such as that described above.

Step 700 receives an application programming interface (API) call from a web page. Any suitable API call can be used. For example, in at least some embodiments, an API call can include an API call made by a web page to an API associated with a browser.

Step 702 determines whether an issue exists with respect to the API call. This determining can be performed by using a code component that wraps an associated API. In at least some embodiments, the code component can be configured to process the API call by monitoring one or more of the input values provided by the call, state values of the web page, and output or return values as a result of the API call. State values of a web page can include, by way of example and not limitation, state associated with elements, styles, javascript, or javascript frameworks. The issues can include any suitable type of compatibility or interoperability issue.

Responsive to determining that an issue exists, step 704 selects a displayable message associated with the issue and causes the message to be displayed.

In at least some embodiments, steps 700-704 can be repeated for all APIs associated with a web page. In other embodiments, steps 700-704 can be repeated for designated APIs that a user may customize Alternatively, steps 700-704 may be performed for those APIs for which there is a code component available to wrap the API.

Having described example methods in accordance with one or more embodiments, consider now an example system that can be utilized to implement one or more of the above-described embodiments.

Example System

FIG. 8 illustrates an example computing device 800 that can be used to implement the various embodiments described above. Computing device 800 can be, for example, computing device 102 of FIG. 1 or any other suitable computing device.

Computing device 800 includes one or more processors or processing units 802, one or more memory and/or storage components 804, one or more input/output (I/O) devices 806, and a bus 808 that allows the various components and devices to communicate with one another. Bus 808 represents one or more of any of several types of bus structures, including a memory bus or memory controller, a peripheral bus, an accelerated graphics port, and a processor or local bus using any of a variety of bus architectures. Bus 808 can include wired and/or wireless buses.

Memory/storage component 804 represents one or more computer storage media. Component 804 can include volatile media (such as random access memory (RAM)) and/or nonvolatile media (such as read only memory (ROM), Flash memory, optical disks, magnetic disks, and so forth). Component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments provide an investigative tool, termed a “code advisor”, to enable webpage content to be analyzed. In at least some embodiments, code advisor allows the use of Application Programming Interfaces (APIs) to be tracked. By tracking API use as script for a webpage executes, code advisor can determine if any compatibility and/or interoperability issues exist in regards to webpage content. If an issue does exist, in at least some embodiments, the code advisor can select one or more messages associated with the issue and provide guidance to enable the issue to be addressed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims

What is claimed is:

1. A computer-implemented method comprising:
receiving an Application Programming Interface (API) call from a web page;
determining whether an issue exists with respect to the API call by using a code component that wraps an associated API and is configured to process the API call and identify one or more issues associated with the API call; and
responsive to determining an issue exists, selecting a displayable message associated with the issue.

2. The computer-implemented method of claim 1, wherein the displayable message comprises:
an error message,
a warn message, or
an information message.

3. The computer-implemented method of claim 1, further comprising:
displaying the displayable message; and
prompting a user to perform an action.

4. The computer-implemented method of claim 3, wherein the action comprises:
selection of a fix option to permit display of an emulated behavior, or
selection of a debug option.

5. The computer-implemented method of claim 4, wherein the emulated behavior comprises a legacy behavior of a previous version of a browser that receives the call.

6. The computer-implemented method of claim 4, wherein the emulated behavior is displayed dynamically and in real time.

7. A system for analyzing web pages comprising:
one or more processors; and
computer readable storage media, embodying computer readable instructions that, when executed by the one or more processors, cause the one or more processors to implement a tool configured to:
load at least one module associated with a script element that has been inserted into a web page;
permit the at least one module to wrap at least one Application Programming Interface (API);
load the web page into which the script element was inserted; and
process one or more calls by the web page to the API using the at least one module.

8. The system of claim 7 wherein processing the one or more calls comprises monitoring information pertaining to the API including:
an input value;
a return value; or
a state of the web page.

9. The system of claim 8, wherein the state of the web page comprises state associated with:
elements;
styles;
javascript; or
javascript frameworks.

10. The system of claim 7, wherein the tool is implemented as a stand-alone tool.

11. The system of claim 7, wherein the script element comprises a javascript element.

12. The system of claim 7, wherein the at least one module is configured to be sharable.

13. The system of claim 7, wherein the at least one module is configured to be loaded from a remote library.

14. The system of claim 7 wherein processing the one or more calls further comprises:
determining whether an issue exists with respect to the one or more calls, and
responsive to determining that an issue exists, redirecting the one or more calls to a different API.

15. The system of claim 14, wherein processing the one or more calls further comprises responsive to determining an issue exists, selecting a displayable message associated with the issue and causing the displayable message to be displayed.

16. The system of claim 15, wherein the displayable message comprises:
an error message,
a warn message, or
an information message.

17. One or more computer-readable storage media comprising computer-readable instructions which, when executed, implement a method comprising:
analyzing an Application Programming Interface (API) call from a web page;
determining that an issue exists with respect to the API call by using a code component that wraps an associated API and is configured to process the API call and identify one or more issues associated with the API call; and
causing display of an indication of how to resolve the issue associated with the API call.

18. The one or more computer-readable storage media of claim 18, wherein the indication comprises:
a link into documentation,
information regarding standards-compliance,
a highlight of code pertaining to the issue,
a list of code pertaining to the issue, or
an automatic correction of code.

19. The one or more computer-readable storage media of claim 17, further comprising: a code component configured to intercept the API call and cause a redirection to a code module effective to cause said code module to perform said analyzing, determining, and causing.

20. The one or more computer-readable storage media of claim 17, wherein the indication is configured to display with at least one option to prompt a user to perform an action, wherein the at least one option comprises:
a fix option to permit display of an emulated behavior, or a debug option.
